(19) United States
(12) Patent Application Publication
(10) Pub. No.: US 2025/0019534 A1
(43) Pub. Date: Jan. 16, 2025

(54) POLYPROPYLENE RESIN COMPOSITION FOR INSULATING LAYER OF POWER CABLE WITH EXCELLENT WHITENING RESISTANCE AND MOLDED ARTICLE USING SAME

(71) Applicant: LOTTE CHEMICAL CORPORATION, Seoul (KR)

(72) Inventors: Youn Kyoung KIM, Daejeon (KR); Bo Sang YOON, Daejeon (KR); Kyo Un SEO, Daejeon (KR)

(21) Appl. No.: 18/712,174

(22) PCT Filed: Sep. 27, 2022
(86) PCT No.: PCT/KR2022/014482

§ 371 Date: May 21, 2024

(30) Foreign Application Priority Data
Nov. 22, 2021 (KR) 10-2021-0161553

(51) Int. Cl. C08L 53/00; H01B 3/44; H01B 9/00

(52) U.S. Cl. CPC C08L 53/00; H01B 3/441; C08L 2203/202; C08L 2205/03; C08L 2207/14; H01B 9/00

(57) ABSTRACT

Disclosed are a resin composition for an insulating layer of a recyclable power cable, and a molded article using the resin composition, wherein the resin composition for an insulating layer of a power cable has excellent whitening resistance while satisfying excellent flexibility and electrical properties. The present invention provides a polypropylene resin composition for an insulating layer of a power cable, and a power cable using the polypropylene resin composition, wherein the polypropylene resin composition includes 70 parts by weight to 90 parts by weight of a propylene block copolymer in which ethylene-propylene rubber (EPR) is dispersed in a propylene-ethylene random copolymer, 5 parts by weight to 20 parts by weight of a polyolefin elastomer (POE), and 5 parts by weight to 20 parts by weight of high molecular weight atactic polypropylene (PP) having a weight average molecular weight of 100,000 g/mol or greater.

### TECHNICAL FIELD

The present invention relates to a resin composition for an insulating layer of an eco-friendly power cable, and more particularly, to a resin composition for an insulating layer of an eco-friendly power cable, which has excellent flexibility and electrical properties, and is recyclable.

This application claims the benefit of Korean Patent Application No. 10-2021-0161553, filed on Nov. 22, 2021, in the Korean Intellectual Property Office, the disclosure of which is incorporated herein in its entirety by reference.

### BACKGROUND ART

As an insulation material of a power cable, material obtained by cross-linking polyethylene (PE), polyvinyl chloride (PVC), ethylene-propylene rubber (EPR), or the like is mainly used. Among them, cross-linked polyethylene (XLPE) is obtained by converting a linear molecular structure of polyethylene into a three-dimensional network structure through a cross-linking process, and has excellent mechanical properties and chemical resistance properties of typical polyethylene while having improved heat resistance, and thus, has been used as an insulating layer for a high-voltage power cable. However, cross-linked polyethylene is a cross-linked polymer, and thus, is not recyclable, and should be incinerated to be disposed, and thus, is not quite environmentally friendly.

Recently, development of a resin for an insulating layer applicable to a distribution line (22.9 kv or greater) using a polypropylene (PP) material, which is easy to recycle and has high heat resistance, has been underway. Compared to an XLPE insulating layer, a polypropylene insulating layer is known to have a simple manufacturing method, to be environmentally friendly due to the non-crosslinked form thereof, and to have excellent performance such as heat resistance and usability. Toxic substances such as methane gas and various by-products are not generated during a manufacturing process of the polypropylene insulating layer, and greenhouse gases such as CO₂ generated during the manufacturing process may be reduced by 30% compared to XLPE. In addition, the polypropylene insulating layer is recyclable, and is highly heat resistant, and thus, is capable of increasing a power transmission capacity, which is advantageous.

However, a power cable including a polypropylene insulating layer has a problem of being poor in cable installation properties due to low flexibility caused by high rigidity, which is a unique characteristic of polypropylene, and being slightly insufficient in electrical properties compared to the XLPE. Therefore, there is a need to develop a composition for an insulating layer, which is environmentally friendly and has high stiffness of polypropylene and improved electrical properties.

Recently, there have been attempts to improve flexibility and electrical properties by using an olefin-based rubber in a polypropylene material. However, a polypropylene material and an olefin-based rubber have heterogeneous properties and do not mix with each other, so that there is a boundary between a matrix phase and a domain, and there is a problem in that tension is applied to the boundary during power line installation, causing the generation of microcrazes in an interface boundary region, thereby causing a whitening phenomenon.

International Patent Publication No. WO2013/148028 discloses a polypropylene blend for a thermoplastic insulator in which ethylene, α-olefin, EPDM, and the like are mixed with polypropylene, and the change in AC breakdown voltage strength according to the cooling rate, but there is no mention of improving heat resistance and softness of the composition, and there may be a problem such as breakage due to poor softness during installation.

Korean Patent Laid-open Publication No. 2014-0040082 discloses a thermoplastic polymer material with softness secured by mixing an α-olefin comonomer rubber phase and a propylene copolymer, but there is a problem in that if the content of the rubber phase is low, softness decreases when used as an insulating material, making construction and installation difficult, and if the content of the rubber phase is high, the advantage of polypropylene, which influences mechanical properties, is lost, and there is a problem in that insulation breakdown strength decreases due to whitening which may occur to a resin composition with heterogeneous properties.

### DISCLOSURE OF THE INVENTION

### Technical Problem

An aspect of the present invention provides a resin composition for an insulating layer of a recyclable power cable, and a molded article using the resin composition, wherein the resin composition for an insulating layer of a power cable has excellent whitening resistance while satisfying excellent flexibility and electrical properties.

### Technical Solution

According to an aspect of the present invention, there is provided a polypropylene resin composition for an insulating layer of a power cable, wherein the polypropylene resin composition includes 70 parts by weight to 90 parts by weight of a propylene block copolymer in which ethylene-propylene rubber (EPR) is dispersed in a propylene-ethylene random copolymer, 5 parts by weight to 20 parts by weight of a polyolefin elastomer (POE), and 5 parts by weight to 20 parts by weight of high molecular weight atactic polypropylene (PP) having a weight average molecular weight of 100,000 g/mol or greater.

In addition, the present invention provides a polypropylene resin composition for an insulating layer of a power cable, wherein an ethylene-derived repeating unit of the propylene block copolymer is included in an amount of 0.1 wt % to 5 wt % in the propylene-ethylene random copolymer, is included in an amount of 30 wt % to 60 wt % in the ethylene-propylene rubber (EPR), and is included in an amount of 5 wt % to 25 wt % in the propylene block copolymer.

In addition, the present invention provides a polypropylene resin composition for an insulating layer of a power cable, wherein the propylene block copolymer has a melting point of 150° C. to 170° C., an enthalpy of fusion of 65 J/g to 85 J/g, a melt index (MI, 230° C., 2.16 kg load) of 0.1 g/10 min to 10 g/10 min, and a xylene soluble of 15 wt % to 50 wt % in the propylene block copolymer.

In addition, the present invention provides a polypropylene resin composition for an insulating layer of a power cable, wherein the propylene block copolymer is obtained by reacting propylene and ethylene in a loop reactor to polymerize a propylene-ethylene random copolymer, and then continuously polymerizing propylene and ethylene in a gas phase reactor in the presence of the propylene-ethylene random copolymer to disperse ethylene-propylene rubber (EPR) in the propylene-ethylene random copolymer.

In addition, the present invention provides a polypropylene resin composition for an insulating layer of a power cable, wherein the polyolefin elastomer includes two or more selected from the group consisting of an ethylene-derived repeating unit, a propylene-derived repeating unit, and a (C4-C12) alpha-olefin-derived repeating unit, and includes the ethylene-derived repeating unit or the propylene-derived repeating unit.

In addition, the present invention provides a polypropylene resin composition for an insulating layer of a power cable, wherein the resin composition has a white index of 40 or less, as measured according to the following method.

### [Method for Measuring White Index]

The resin composition is prepared in the form of a sheet having a thickness of 2 mm at 230° C. by using a press molding machine, and then cooled at 10° C. for 5 minutes to prepare a sample (60×45×2 mm), and then the sample is subjected to bending evaluation performed by applying a force of 10 N, and the white index of the sample, which has been subjected to the bending evaluation, is measured according to the ASTM E313 standard by using a spectrophotometry device (Ecolorplus Co., 7000A_IQPC).

In addition, the present invention provides a polypropylene resin composition for an insulating layer of a power cable, wherein the resin composition has a flexural modulus of 300 MPa to 550 MPa, an AC dielectric breakdown strength of 50 kV/mm or greater, and an impulse dielectric breakdown strength of 90 kV/mm or greater, measured according to the following method.

### [Method for Measuring Flexural Modulus]

According to the ASTM D790 standard, the support span of a specimen (127×12.7×6.4 mm) is fixed at 100 mm, and a flexural load is applied at a rate of 28 mm/min to determine a measured value as the flexural modulus.

### [Method for Measuring Dielectric Breakdown Strength]

The resin composition is prepared in the form of a sheet having a thickness of 1 mm by using a press molding machine, and then cooled at 10° C. for 5 minutes, and then according to the ASTM D149 standard, 30 kV is initially applied for 5 minutes, and thereafter, is increased by 10 kV and maintained for 5 minutes, the process of which is repeated until insulation breakdown occurs, and when the insulation breakdown occurs, the voltage at that time is determined as AC dielectric breakdown strength, and an impact voltage of 80 kV is applied to the sheet in positive/negative polarity 10 times each, and thereafter, the impact voltage is increased by 10 kV and an impulse voltage is applied 3 times, the process of which is repeated until breakdown occurs, and when the insulation breakdown occurs, the voltage at that time is determined as impulse breakdown strength.

According to another aspect of the present invention, there is provided a power cable including the resin composition as an insulating layer.

### Advantageous Effects

The present invention may provide a resin composition for an insulating layer of a power cable, and a power cable using the resin composition, wherein the resin composition is a resin composition for an insulating layer of a recyclable power cable and satisfies excellent flexibility properties and electrical properties and has excellent whitening resistance by using a propylene block copolymer in which ethylene-propylene rubber (EPR) is dispersed in a propylene-ethylene random copolymer, and high molecular weight atactic polypropylene in a polyolefin elastomer.

### BRIEF DESCRIPTION OF THE DRAWINGS

FIG. 1 is a diagram schematically showing a cross-section of a power cable manufactured using a resin composition according to the present invention.

FIG. 2 is a photograph showing the result of observing a cross-section of a sample by using an optical microscope, the sample which has been subjected to bending evaluation in a test example.

### BEST MODE FOR CARRYING OUT THE INVENTION

Hereinafter, the present invention will be described in detail with reference to preferred embodiments. Prior to this, it will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention. Therefore, the configurations of the embodiments described herein are merely the most preferred embodiments of the present invention, and are not intended to limit the technical idea of the present invention. Therefore, it should be understood that there may be various equivalents and modifications that may substitute the embodiments at the time of the present application.

The present invention discloses a polypropylene resin composition for an insulating layer of a power cable, wherein the polypropylene resin composition includes 70 parts by weight to 90 parts by weight of a propylene block copolymer in which ethylene-propylene rubber (EPR) is dispersed in a propylene-ethylene random copolymer, 5 parts by weight to 20 parts by weight of a polyolefin elastomer (POE), and 5 parts by weight to 20 parts by weight of high molecular weight atactic polypropylene (PP) having a weight average molecular weight of 100,000 g/mol or greater.

Hereinafter, each component of the resin composition for an insulating layer of a power cable according to the present invention will be described in detail.

Polypropylene may be classified into a homo polypropylene (H-PP), a propylene random copolymer (R-PP) and a propylene block copolymer (B-PP). Among them, the propylene random copolymer and the propylene block copolymer have higher flexibility and flexural properties than the homo polypropylene, and thus, are more suitable for a power cable, and here, the propylene block copolymer has the advantage of being excellent in flexibility and flexural properties compared to the propylene random copolymer, so that the propylene block copolymer is used in the present invention.

In the present invention, the propylene block copolymer is a kind of a reactor-made thermoplastic polyolefin elastomer (RTPO), and refers to a polymer including a polymer which exhibits a plurality of rubber properties in the polymer including a unit derived from a propylene monomer.

In the present invention, the propylene block copolymer is obtained by reacting propylene and ethylene in a loop reactor to polymerize a propylene-ethylene random copolymer, and then subjecting gases of propylene and ethylene to a copolymerization reaction in a gas phase reactor in the presence of the propylene-ethylene random copolymer by continuous polymerization to disperse the ethylene-propylene rubber (EPR) in the propylene-ethylene random copolymer, and due to the preparation through continuous polymerization as described above, it is possible to uniformly disperse the ethylene-propylene rubber (EPR) into small-sized domains inside a polypropylene matrix.

Here, in the present invention, the size and degree of dispersion of the domains of the ethylene-propylene rubber (EPR) are not limited, but in consideration of the flexibility and electrical properties of a final resin composition, the average size of the domains may be 0.1 μm to 5 μm, preferably 0.5 μm, to 2 μm, and the dispersion degree of the domains may be 0.1 to 0.7, preferably 0.2 to 0.6. The size and degree of dispersion of the domains may be measured by compression-molding (4 min at 220° C.) the resin composition to prepare a specimen and cutting the prepared specimen to 1 mm wide and 10 cm long, and then immersing the cut specimen in xylene at 60° C. to elute ethylene-propylene rubber, followed by analyzing voids present on the surface of the specimen by scanning electron microscopy (SEM).

In the present invention, the propylene block copolymer may include 50 wt % to 85 wt % of the propylene-ethylene random copolymer and 15 wt % to 50 wt % of the ethylene-propylene rubber, and preferably, may include 60 wt % to 75 wt % of the propylene-ethylene random copolymer and 25 wt % to 40 wt % of the ethylene-propylene rubber. The propylene block copolymer is a form in which ethylene-propylene rubber particles are dispersed in a propylene-ethylene random copolymer matrix. Specifically, the propylene block copolymer may be a block copolymer in which an ethylene-propylene rubber is polymerized in a stepwise manner in a propylene-ethylene random copolymer in a reactor. The propylene block copolymer has the ethylene-propylene rubber dispersed in a specific content range, and thus, has a lower flexural modulus than the propylene homopolymer or the propylene-ethylene random copolymer, so that when applied as an insulating layer of a power cable, flexibility improvement may be maximized, and strength may be improved due to excellent elasticity.

In the present invention, the propylene block copolymer is obtained by producing a large amount of ethylene-propylene rubber (EPR) by using a high-content ethylene in a polymerization reactor, and includes a repeating unit derived from a high content of ethylene-propylene rubber (EPR) compared to a typical propylene block copolymer, and thus, has the advantage of having high strength and excellent flexibility.

Although not limited by theory, in general, a propylene block copolymer prepared in a reactor may have a content of an ethylene-derived repeating unit of 5 wt % to 25 wt %, preferably 10 wt % to 20 wt, in the total block copolymer due to technical difficulties. In addition, the content of the ethylene-derived repeating unit may be 0.1 wt % to 5 wt %, preferably 0.1 wt % to 3 wt %, more preferably 0.5 wt % to 2 wt %, in the propylene-ethylene random copolymer, and may be 30 wt % to 60 wt %, preferably 40 wt % to 50 wt %, in the ethylene-propylene rubber (EPR). The flexibility, flexural properties, and electrical properties may be maximized in the above-described content range of the ethylene-derived repeating unit. In addition, if the content of the ethylene-derived repeating unit is greater than 5 wt % in the propylene-ethylene random copolymer, the melting point of the block copolymer is lowered, so that the heat resistance stability may be degraded.

In addition, the propylene block copolymer may have a melting point of 150° C. to 170° C., preferably 160° C. to 170° C. In addition, the enthalpy of fusion may be 65 J/g to 85 J/g, preferably 75 J/g to 85 J/g. If the melting point and the enthalpy of fusion of the propylene block copolymer satisfy the above-described ranges, when applied as an insulating layer of a power cable, flexibility and electrical properties to be implemented in the present invention may be satisfied.

In addition, the propylene block copolymer may have a melt index MI (230° C., 2.16 kg load) of 0.1 g/10 min to 10 g/10 min, preferably 0.3 g/10 min to 5 g/10 min, and more preferably 0.5 g/10 min to 2 g/10 min. If the melt index is less than 0.1 g/10 min, an extruder may be overloaded during a cable extrusion, and if greater than 10 g/10 min, insulating layer eccentricity of a cable molded article may occur.

In addition, the propylene block copolymer may have a xylene soluble (X.S.) of 15 wt % to 50 wt %, preferably 25 wt % to 40 wt %, in the propylene block copolymer. The xylene soluble is in accordance with the content of the ethylene-propylene rubber (EPR) included in the propylene block copolymer, and the flexibility, flexural properties, and electrical properties may be maximized in the above-described content range.

In the present invention, the propylene block copolymer may be included in an amount of 70 parts by weight to 90 parts by weight, preferably 75 parts by weight to 85 parts by weight. If the content of the propylene block copolymer is less than 70 parts by weight, the electrical properties may be degraded and whitening may occur, and if greater than 90 parts by weight, the flexibility is degraded.

In the present invention, a polyolefin elastomer (POE) is included as a modifier for improving the flexibility and flexural properties of a final resin composition.

The polyolefin elastomer includes two or more selected from the group consisting of an ethylene-derived repeating unit, a propylene-derived repeating unit, and a (C4-C12) alpha-olefin-derived repeating unit, and may include the ethylene-derived repeating unit or the propylene-derived repeating unit. For example, it may be a copolymer of ethylene and propylene, or a random or block copolymer elastomer of an alpha-olefin with one of ethylene and propylene and 1-butene, 1-pentene, 1-hexene, 1-octene, etc., or a combination of these elastomers. More preferably, propylene-ethylene rubber (PER) or ethylene-1-octene rubber (EOR) may be used, and most preferably, the propylene-ethylene rubber (PER) may be used.

The polyolefin elastomer (POE) may be included in an amount of 5 parts by weight to 20 parts by weight, preferably 5 parts by weight to 15 parts by weight. If the content of the polyolefin elastomer (POE) is less than 5 parts by weight, the flexibility of the final resin composition is degraded, and if greater than 20 parts by weight, the electrical properties thereof are degraded.

The atactic polypropylene serves to effectively fill the interface if voids are generated at the interface between the propylene block copolymer and the polyolefin elastomer (POE), and in the present invention, a high-molecular weight atatic polypropylene (PP) having a weight average molecular weight (Mw) of 100,000 g/mol or greater, preferably 120,000 g/mol or greater, and more preferably 120,000 g/mol to 1,000,000 g/mol, may be used.

If the molecular weight of the atactic polypropylene is low, it may cause the dielectric breakdown strength to deteriorate under a high voltage, and if a high tension force is applied, the effect of reducing the whitening phenomenon is not significant.

The atactic polypropylene (PP) may be included in an amount of 5 parts by weight to 20 parts by weight, preferably 5 parts by weight to 15 parts by weight. If the content of the atactic polypropylene (PP) is less than 5 parts by weight, the effect of reducing the whitening phenomenon of the resin composition is insignificant, and if greater than 20 parts by weight, the dielectric breakdown strength is lowered.

In the present invention, the atactic polypropylene (PP) has flexible crystal spherulites, and thus, serves to lower the flexural modulus of the final resin composition, and also, is mixed with a propylene block copolymer including the propylene-ethylene random copolymer, and thus, may exhibit a remarkable effect in reducing the whitening phenomenon and improving the dielectric breakdown strength compared to when mixed with a propylene block copolymer including a propylene homopolymer.

The above-described atactic polypropylene (PP) is an amorphous polypropylene having an isotactisity (Pentad I.I, mmmm) of 5% to 20%, preferably 5% to 15%, which may be prepared according to a method known in the art, and for example, may be prepared with reference to Patent Application No. 2011-0033626 filed by the present applicant, and the patent may be incorporated herein by reference.

In addition to the above-described components, the resin composition according to the present invention may further include one or more additives commonly used when applied to an insulating layer of a power cable, and preferably, may further include an antioxidant, a neutralizer or a water tree inhibitor.

The antioxidant may be added to impart color stability and transparency by suppressing yellowing of the resin composition. Any antioxidant may be used without limitation as long as it can prevent oxidation of the resin composition for an insulating layer of a power cable, but one or more antioxidants selected from the group consisting of a hindered phenol-based antioxidant, 4,4′-thiobis(2-t-butyl-5-methylphenol), 2,2′-thio-diethyl-bis [3-(3,5-di-t-butyl-4-hydroxyphenyl) propionate], 4,4′-thiobis(2-methyl-6-t-butylphenol), 2,2′-thiobis(6-t-butyl-4-methylphenol), octadecyl [3-(3,5-di-t-butyl-4-hydroxyphenyl) propionate], and thiodiethylene-bis [3-(3,5-di-t-butyl-4-hydroxyphenyl) propionate] may be used.

The neutralizer is used to prevent decomposition of a resin composition by effectively removing a catalyst residue remaining after polymerization, and any neutralizer may be used without limitation as long as it can prevent decomposition of the resin composition for an insulating layer of a power cable.

The water tree inhibitor is added for the purpose of preventing water tree, which is a micro-destruction form that occurs due to a combined action of moisture and voltage at a voltage below a breakdown voltage and gradually grows. The water tree phenomenon degrades electrical insulating properties of the insulating layer, thereby causing a decrease in lifespan of the insulating layer. Any water tree inhibitor may be used without limitation as long as it is a material that can reduce a combined action of moisture and voltage.

The polyolefin resin composition for an insulating layer of a power cable according to the present invention may be prepared by mixing and extruding the above-described components according to a typical method known in the art. For example, the above-described components may be introduced into a twin-screw extruder and melt-kneaded to prepare the resin composition.

The resin composition for an insulating layer of a power cable according to the present invention has excellent whitening resistance while satisfying excellent flexibility and electrical properties, is environmentally friendly, and thus, is recyclable, and specifically, as measured according to the following methods, may have a white index of 40 or less, preferably 35 or less, a flexural modulus of 300 MPa to 550 MPa, preferably 350 MPa to 500 MPa, an AC dielectric breakdown strength of 50 kV/mm or greater, preferably 55 kV/mm or greater, an impulse dielectric breakdown strength of 90 kV/mm or greater, preferably 95 kV/mm or greater.

### [Method for Measuring White Index]

The resin composition is prepared in the form of a sheet having a thickness of 2 mm at 230° C. by using a press molding machine, and then cooled at 10° C. for 5 minutes to prepare a sample (60×45×2 mm), and then the sample is subjected to bending evaluation performed by applying a force of 10 N, and the white index of the sample, which has been subjected to the bending evaluation, is measured according to the ASTM E313 standard by using a spectrophotometry device (Ecolorplus Co., 7000A_IQPC).

### [Method for Measuring Flexural Modulus]

According to the ASTM D790 standard, the support span of a specimen (127×12.7×6.4 mm) is fixed at 100 mm, and a flexural load is applied at a rate of 28 mm/min to determine a measured value as the flexural modulus.

### [Method for Measuring Dielectric Breakdown Strength]

The resin composition is prepared in the form of a sheet having a thickness of 1 mm by using a press molding machine, and then cooled at 10° C. for 5 minutes, and then according to the ASTM D149 standard, 30 kV is initially applied for 5 minutes, and thereafter, is increased by 10 kV and maintained for 5 minutes, the process of which is repeated until insulation breakdown occurs, and when the insulation breakdown occurs, the voltage at that time is determined as AC dielectric breakdown strength, and an impact voltage of 80 kV is applied to the sheet in positive/negative polarity 10 times each, and thereafter, the impact voltage is increased by 10 kV and an impulse voltage is applied 3 times, the process of which is repeated until breakdown occurs, and when the insulation breakdown occurs, the voltage at that time is determined as impulse breakdown strength.

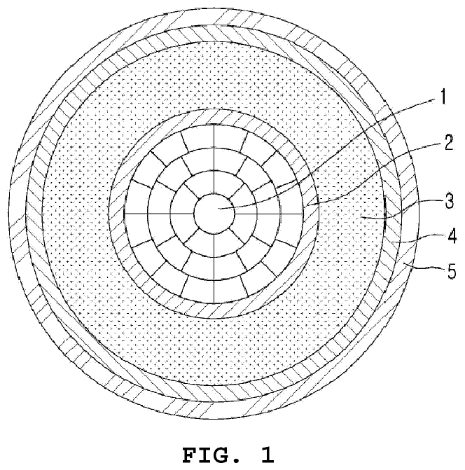

A power cable may be manufactured using the above-described polypropylene resin composition for an insulating layer of a power cable according to the present invention. FIG. 1 schematically shows a cross-section of a power cable manufactured using the resin composition according to the present invention.

Referring to FIG. 1, the power cable manufactured using the resin composition for an insulating layer of a power cable according to the present invention includes a conductor 1, an inner semi-conductive layer 2 surrounding the conductor 1, an insulating layer 3 surrounding the inner semi-conductive layer 2, an outer semi-conductive layer 4 surrounding layer 3, and a sheath layer surrounding the outer semi-conductive layer 4. Except for the insulating layer, details of each layer constituting the power cable are commonly known to those skilled in the art, so that detailed descriptions thereof will be omitted in the present invention.

Hereinafter, specific preparation examples, examples, and comparative examples according to the present invention will be described.

### Preparation Example 1: Preparation of Propylene Block Copolymer (Resin 1)

Propylene and ethylene were reacted in a loop reactor to obtain a propylene-ethylene random copolymer, and the propylene-ethylene random copolymer polymerized in the loop reactor, ethylene, and propylene were introduced into a gas phase reactor to perform a copolymerization reaction of ethylene-propylene in a continuous process, thereby preparing a propylene block copolymer. The prepared propylene block copolymer included an ethylene-derived repeating unit in an amount of 1 wt % in the propylene-ethylene random copolymer, 43 wt % in the ethylene-propylene rubber (EPR), and 15 wt % in the total copolymer, and had a xylene soluble content of 29 wt %, a melt index of 1 g/10 min, a melting point of 150.7° C., and an enthalpy of fusion of 67.4 J/g. The melt index, xylene soluble content, melting point, and enthalpy of fusion of the propylene block copolymer were respectively measured according to the following methods.
Melt Index (MI): Measured under the conditions of a temperature of 230° C. and a load of 2.16 kg according to the ASTM D1238 standard.
Xylene Soluble (X.S.): According to the ASTM D5492 standard, the propylene block copolymer was dissolved in boiling xylene, cooled at room temperature, and then separated into portions dissolved in the xylene and portions not dissolved therein, and the portions dissolved in the xylene were separately collected to evaporate the xylene using a hot plate, and the wt % of the remaining portions after the evaporation were measured.
Melting point and enthalpy of fusion: Using a differential scanning (DSC), was calorimeter heating performed to 200° C. at a rate of 10° C./min and then cooling was performed to −30° C., the whole process of which was repeated two times to use data measured after the second time.

### Comparative Preparation Example 1: Preparation of Propylene Block Copolymer (Resin 2)

A propylene block copolymer was prepared in the same manner as in Preparation Example of Resin 1, except that propylene was reacted in the loop reactor to obtain a propylene homopolymer in Preparation Example 1. The prepared propylene block copolymer included an ethylene-derived repeating unit in an amount of 42 wt % in the ethylene-propylene rubber (EPR) and 14 wt % in the total copolymer, and had a xylene soluble content of 29 wt %, a melt index of 1 g/10 min, a melting point of 163.7° C., and an enthalpy of fusion of 77.4 J/g.

### Polyolefin Elastomer (POE) (Resin 3)

Propylene-ethylene rubber (PER) (Vistamaxx™ 3020FL, Exxonmobil chemical Co., melting point 60.2° C., specific gravity 0.874) was prepared as a polyolefin elastomer.

### Preparation Example 2: Preparation of Atactic Polypropylene (PP) (Resin 4)

Reference was made to Patent Application No. 2011-0033626. At room temperature, the inside of a high-pressure reactor (internal capacity: 21, stainless steel) was substituted with nitrogen, and about 4.0 ml of a methylaluminoxane toluene solution (a solution of 10 wt % of methylaluminoxane in toluene, 6 mmol based on Al, manufacturer: Albemarle) was added to the reactor, followed by adding 500 g of propylene thereto, and the temperature was raised to 70° C. Subsequently, a solution (1.5 ml, 3.0 μmol of Ti) in which a transition metal compound represented by Formula 1 was dissolved in toluene was injected into the reactor, and polymerization was performed. After the polymerization reaction was performed, the temperature was lowered to room temperature, excess propylene was removed, and the polymer was recovered. The obtained polymer heated to 80° C. in a vacuum oven and dried for 4 hours or more to prepare atactic polypropylene (xylene soluble content of 98 wt %, MI (230° C., 2.16 kg load) of 2 g/10 min, Mw (measured by GPC analysis, PL-GPC220, Agilent) of 320,000 g/mol, Tg (glass transition temperature) of −5° C., I. I. (%, mmmm) of 2).

### Preparation Example 3: Preparation of Atactic Polypropylene (PP) (Resin 5)

The amount of propylene input, the amount of catalyst used, the reaction time, etc. were adjusted in Preparation Example 2 to prepare atactic polypropylene having a xylene soluble content of 98 wt %, an MI (230° C., 2.16 kg load) of 50 g/10 min, an Mw (measured by GPC analysis, PL-GPC220, Agilent) of 120,000 g/mol, a Tg (glass transition temperature) of −5° C., and an I.I. (%, mmmm) of 1.5.

### Comparative Preparation Example 2: Preparation of Atactic Polypropylene (Resin 6)

The amount of propylene input, the amount of catalyst used, the reaction time, etc. were adjusted in Preparation Example 2 to prepare atactic polypropylene having a xylene soluble content of 98 wt %, an MI (230° C., 2.16 kg load) of 100 g/10 min, an Mw (measured by GPC analysis, PL-GPC220, Agilent) of 40,000 g/mol, a Tg (glass transition temperature) of −5° C., and an I. I. (%, mmmm) of 1.9.

### Examples and Comparative Examples

A mixture composed of component compositions of Table 1 below was mixed for 5 minutes using a mixer, and then extruded using a two-axis extruder under conditions of 190° C. to 230° C. to prepare a resin composition in a pellet phase.

### Test Example

Using the prepared resin composition in a pellet phase, the flexural properties, electrical properties, and white index were measured according to the following methods and the results are shown in Table 1 below.

### [Measurement Method]

### (1) Flexural Modulus

According to the ASTM D790 standard, the support span of a specimen (127×12.7×6.4 mm) was fixed at 100 mm, and a flexural load was applied at a rate of 28 mm/min to determine a measured value as the flexural modulus. If the flexural modulus is 550 MPa or less, the flexibility and flexural properties are determined to be good, and if the flexural modulus is 500 MPa or less, the same are determined to be excellent.

### (2) Dielectric Breakdown Strength

The resin composition was prepared in the form of a sheet having a thickness of 1 mm by using a press molding machine, and then cooled at 10° C. for 5 minutes, and then according to the ASTM D149 standard, 30 kV was initially applied for 5 minutes, and thereafter, was increased by 10 kV and maintained for 5 minutes, the process of which was repeated until insulation breakdown occurred, and when the insulation breakdown occurred, the voltage at that time was determined as AC dielectric breakdown strength, and an impact voltage of 80 KV was applied to the sheet in positive/negative polarity 10 times each, and thereafter, the impact voltage was increased by 10 kV and an impulse voltage was applied 3 times, the process of which was repeated until breakdown occurred, and when the insulation breakdown occurred, the voltage at that time was determined as impulse breakdown strength. If the AC dielectric breakdown strength is 50 kV/mm or greater and the impulse dielectric breakdown strength is 90 kV/mm or greater, the electrical properties are determined to be excellent.

### (3) White Index (Whitening Phenomenon)

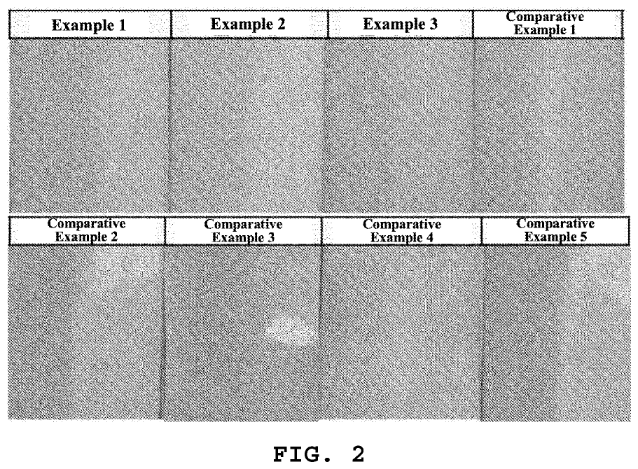

The resin composition was prepared in the form of a sheet having a thickness of 2 mm at 230° C. by using a press molding machine, and then cooled at 10° C. for 5 minutes to prepare a sample (60×45×2 mm), and then the sample was subjected to bending evaluation performed by applying a force of 10 N, and the white index of the sample, which was subjected to the bending evaluation, was measured according to the ASTM E313 standard by using a spectrophotometry device (Ecolorplus Co., 7000A_IQPC). In addition, the cross-section of the specimen which was subjected to the bending evaluation was observed using an optical microscope (observation temperature 134° C., magnification ×100, 2 min), and the result is shown in FIG. 2.

TABLE 1

| | | | | Comparative | Comparative | Comparative | Comparative | Comparative |
|---|---|---|---|---|---|---|---|---|
| Classification | Example 1 | Example 2 | Example 3 | Example 1 | Example 2 | Example 3 | Example 4 | Example 5 |
| Resin 1 (parts | 75 | 80 | 75 | 90 | 87 | 70 | — | 75 |
| by weight) | | | | | | | | |
| Resin 2 (parts | — | — | — | — | — | — | 75 | — |
| by weight) | | | | | | | | |
| Resin 3 (parts | 10 | 10 | 10 | 10 | 10 | 10 | 10 | 10 |
| by weight) | | | | | | | | |
| Resin 4 (parts | 15 | 5 | — | — | 3 | 25 | 15 | — |
| by weight) | | | | | | | | |
| Resin 5 (parts | — | — | 15 | — | — | — | — | — |
| by weight) | | | | | | | | |
| Resin 6 (parts | — | — | — | — | — | — | — | 15 |
| by weight) | | | | | | | | |
| Flexural modulus | 450 | 500 | 460 | 580 | 560 | 510 | 530 | 470 |
| (MPa) | | | | | | | | |
| White index | 28 | 31 | 30 | 65 | 60 | 33 | 55 | 42 |
| (white index) | | | | | | | | |
| AC dielectric | 56 | 57 | 56 | 48 | 50 | 53 | 51 | 52 |
| breakdown | | | | | | | | |
| strength | | | | | | | | |
| (kV/mm) | | | | | | | | |
| Impulse | 95 | 97 | 95 | 71 | 83 | 89 | 85 | 91 |
| dielectric | | | | | | | | |
| breakdown | | | | | | | | |
| strength | | | | | | | | |
| (kV/mm) | | | | | | | | |

Referring to Table 1 and FIG. 2 above, the resin compositions (Examples 1 to 3) for an insulating layer of a power cable, the resin compositions using a propylene block copolymer in which ethylene-propylene rubber (EPR) is dispersed in a propylene-ethylene random copolymer and a high molecular weight atactic polypropylene in a polyolefin elastomer are recyclable resin compositions, and it can be confirmed that the resin compositions implement excellent whitening resistance while satisfying excellent flexibility and electrical properties.

On the contrary, it can be seen that when atactic polypropylene was not used (Comparative Example 1), the flexibility, electrical properties, and whitening resistance were all poor, and even when atactic polypropylene was used, if the molecular weight thereof did not reach a certain level (Comparative Example 5), the whitening resistance was not satisfactory, and even when a certain level of high molecular weight atactic polypropylene was used, if the content thereof is too low (Comparative Example 2), the electrical properties and whitening resistance were poor, and when the content thereof was too high (Comparative Example 3), the flexural properties were degraded, and when a matrix component of the propylene block copolymer was used as a propylene homopolymer (Comparative Example 4), the electrical properties were not satisfactory and the flexural properties and whitening resistance were significantly degraded.

The preferred embodiments of the present invention have been described in detail. The description of the present invention has been presented for purposes of illustration, and it will be understood by those skilled in the art that various changes in form and details may be made therein without departing from the spirit and scope of the invention.

Therefore, the scope of the present invention is represented by the following claims rather than the above detailed description, and all changes and changed forms derived from the meaning, scope, and equivalent concepts of the claims should be construed as being included in the scope of the present invention.

1. A polypropylene resin composition for an insulating layer of a power cable, the polypropylene resin composition comprising:
70 parts by weight to 90 parts by weight of a propylene block copolymer in which ethylene-propylene rubber (EPR) is dispersed in a propylene-ethylene random copolymer;
5 parts by weight to 20 parts by weight of a polyolefin elastomer (POE); and
5 parts by weight to 20 parts by weight of high molecular weight atactic polypropylene (PP) having a weight average molecular weight of 100,000 g/mol or greater.

2. The polypropylene resin composition of claim 1, wherein an ethylene-derived repeating unit of the propylene block copolymer is included in an amount of 0.1 wt % to 5 wt % in the propylene-ethylene random copolymer, is included in an amount of 30 wt % to 60 wt % in the ethylene-propylene rubber (EPR), and is included in an amount of 5 wt % to 25 wt % in the propylene block copolymer.

3. The polypropylene resin composition of claim 1, wherein the propylene block copolymer has a melting point of 150° C. to 170° C., an enthalpy of fusion of 65 J/g to 85 J/g, a melt index (MI, 230° C., 2.16 kg load) of 0.1 g/10 min to 10 g/10 min, and a xylene soluble of 15 wt % to 50 wt % in the propylene block copolymer.

4. The polypropylene resin composition of claim 1, wherein the propylene block copolymer is obtained by reacting propylene and ethylene in a loop reactor to polymerize a propylene-ethylene random copolymer, and then continuously polymerizing propylene and ethylene in a gas phase reactor in the presence of the propylene-ethylene random copolymer to disperse ethylene-propylene rubber (EPR) in the propylene-ethylene random copolymer.

5. The polypropylene resin composition of claim 1, wherein the polyolefin elastomer comprises two or more selected from the group consisting of an ethylene-derived repeating unit, a propylene-derived repeating unit, and a (C4-C12) alpha-olefin-derived repeating unit, and comprises the ethylene-derived repeating unit or the propylene-derived repeating unit.

6. The polypropylene resin composition of claim 1, wherein the resin composition has a white index of 40 or less, as measured according to the following method:
[Method for measuring white index]
wherein the resin composition is prepared in the form of a sheet having a thickness of 2 mm at 230° C. by using a press molding machine, and then cooled at 10° C. for 5 minutes to prepare a sample (60×45×2 mm), and then the sample is subjected to bending evaluation performed by applying a force of 10 N, and the white index of the sample, which has been subjected to the bending evaluation, is measured according to the ASTM E313 standard by using a spectrophotometry device (Ecolorplus Co., 7000A_IQPC).

7. The polypropylene resin composition of claim 1, wherein the resin composition has a flexural modulus of 300 MPa to 550 MPa, an AC dielectric breakdown strength of 50 kV/mm or greater, and an impulse dielectric breakdown strength of 90 kV/mm or greater, as measured according to the following method:
[Method for measuring flexural modulus]
wherein according to the ASTM D790 standard, the support span of a specimen (127×12.7×6.4 mm) is fixed at 100 mm, and a flexural load is applied at a rate of 28 mm/min to determine a measured value as the flexural modulus;
[Method for measuring dielectric breakdown strength]
wherein the resin composition is prepared in the form of a sheet having a thickness of 1 mm by using a press molding machine, and then cooled at 10° C. for 5 minutes, and then according to the ASTM D149 standard, 30 KV is initially applied for 5 minutes, and thereafter, is increased by 10 KV and maintained for 5 minutes, the process of which is repeated until insulation breakdown occurs, and when the insulation breakdown occurs, the voltage at that time is determined as AC dielectric breakdown strength, and an impact voltage of 80 KV is applied to the sheet in positive/negative polarity 10 times each, and thereafter, the impact voltage is increased by 10 kV and an impulse voltage is applied 3 times, the process of which is repeated until breakdown occurs, and when the insulation breakdown occurs, the voltage at that time is determined as impulse breakdown strength.

8. A power cable comprising the resin composition of claim 1 as an insulating layer.
